(19) United States
(12) Patent Application Publication
(10) Pub. No.: US 2007/0171527 A1
(43) Pub. Date: Jul. 26, 2007

(54) Gel, polarizer laminated by the gel, and polarizer fabrication method

(75) Inventors: Hong Jie Chen, Yilan County (TW); Cheng Hsin Tsai, Taoyuan (TW)

Correspondence Address: QUINTERO LAW OFFICE, PC, 2210 MAIN STREET, SUITE 200, SANTA MONICA, CA, 90405, US

(73) Assignee: DAXON TECHNOLOGY INC., TAOYUAN (TW)

(21) Appl. No.: 11/373,804

(22) Filed: Mar. 9, 2006

(30) Foreign Application Priority Data
Jan. 23, 2006 (TW) TW95102448

(51) Int. Cl. G02B 5/30

(52) U.S. Cl. 359/490

(57) ABSTRACT

A gel utilized in polarizer lamination. The gel includes a polyvinyl alcohol solution and a water-soluble organic dye dissolved therein. The invention also provides a polarizer laminated by the gel and a fabrication method thereof.

### BACKGROUND OF THE INVENTION

1. Field of the Invention

The invention relates to a gel, and in particular relates to a gel utilized in polarizer lamination, a polarizer laminated thereby, and a polarizer fabrication method.

2. Description of the Related Art

In recent years, there has been an increasing demand for polarization film because of wide use of liquid crystal display (LCD) in various apparatuses such as liquid crystal monitors, cell phones, portable computers, or liquid crystal televisions. Various liquid crystal panel fabrication techniques have been rapidly developed such as in-plane switching (IPS), vertical alignment (VA), or multi-domain vertical alignment (MVA). Thus, polarizers having various optical properties or color dispersions are required to meet the market requirements.

Liquid crystal panels have been developed from conventional smaller size utilized in monitors (such as 12, 15, 17, and 19 inch) to larger size due to increasing popularity of LCD TVs. In the future, LCD TV will become a mainstream due to lower weight, smaller size, larger contrast, and higher color saturation than conventional cold cathode fluorescent lamp (CCFL) TV.

Polarizers laminated on upper and lower surfaces of liquid crystal panel can control light transmittance. When light passes through the lower polarizer, it is converted into a single directional polarized light. Next, phase angle of the single directional polarized light may be altered by applying various panel driving voltages due to specific optical rotation of liquid crystals. Other light with various wavelengths may also produce different phase angles after passing through liquid crystals. As a result, various color images may be displayed from different viewing angles, but these are unacceptable for large polarizers utilized in LCD TV. In order to solve the problem, one or more compensative films laminated on the polarizer can offset phase angle variations.

Commonly, compensative film is formed by dual-axis extending or liquid crystal coating. Compensative film can compensate phase angle variations of light by formation of various refraction indexes along three axes (x, y, z), modifying color dispersion. According to considerations of panel fabrication such as various panel designs or marketing strategy, polarizers providing suitable color dispersions are required.

Polarizer manufacturers usually adjust manufacturing process or utilize compensative films with various retardation values to meet the market requirements. These methods, however, are uneconomical. Modification of process may reduce stability and yield. Also, development of various compensative films is difficult in researching and manufacturing. Thus, it is necessary to develop a polarizer with rapidly adjusted color dispersion, without process modification.

### BRIEF SUMMARY OF THE INVENTION

The invention provides a gel utilized in polarizer lamination process comprising a polyvinyl alcohol solution and a water-soluble organic dye dissolved therein.

The invention also provides a polarizer comprising a polyvinyl alcohol film and at least one protective film laminated thereon by the disclosed gel.

The invention further provides a method of fabricating a polarizer comprising providing a polyvinyl alcohol film and laminating at least one protective film thereon by the disclosed gel.

A detailed description is given in the following embodiments

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a gel utilized in polarizer lamination process comprising a polyvinyl alcohol solution and a water-soluble organic dye dissolved therein.

The polyvinyl alcohol solution has concentration of about 1˜10 wt %, preferably 2˜5%. The water-soluble organic dye may comprise blue, red, yellow, or a mixture thereof such as blue 155, red 345, or yellow 155 (BASF Chemical Co.).

The volatility of the gel can be increased by adding a polar organic solvent such as methanol. The gel exhibits transparency due to uniform dissolution and dispersion of the water-soluble organic dye therein.

The invention also provides a polarizer comprising a polyvinyl alcohol film and at least one protective film laminated thereon by the disclosed gel.

The protective film may comprise triacetyl cellulose (TAC), polyethylene terephathalate (PET), cycloolefin polymer (COP), cycloolefin copolymer (COC), or polynorbomene. The protective film may further be laminated a single or multiple optical films such as compensative film, brightness enhancement film, anti-reflective film, or a combination thereof by an adhesive such as pressure sensitive adhesive (PSA).

The polarizer of the invention has a color dispersion altered with various organic dyes added to the gel. The transmittance and polarizing index of the polarizer can be adjusted to meet practical requirements. When the polarizer is utilized in TFT-LCD, it has a transmittance of about 40.0˜60.0%, preferably 40.0˜50.0%, most preferably 40.0˜45.0%, and a polarizing index exceeding 99.8% after consideration of panel contrast. When the polarizer is utilized in display devices utilizing OLEDs as light source, it has a transmittance of about 40.0˜70.0%, preferably 50.0˜70.0%, most preferably 50.0˜60.0%, and a polarizing index exceeding 60.0%.

The polarizers exhibiting various color dispersions are prepared by adjusting concentration, color, or composition ratio of dyes. Additionally, high transmittance thereof can be remained due to addition of dye with low concentration.

The polarizer of the invention can be applied in various TFT-LCDs and OLED displays, particularly, in large LCD-TV panel.

The invention further provides a method of fabricating a polarizer, comprising the following steps. A polyvinyl alcohol film is provided. At least one protective film is then laminated thereon by the disclosed gel to prepare a polarizer.

Before laminating, the polyvinyl alcohol film may further be processed, for example, swollen in a water tank, dyed with an iodine solution, stretched in an extending tank containing a cross-linking agent, and dried in an oven.

The iodine solution may comprise molecular iodine and iodide ions. The molecular iodine has a weight percentage of about 0.01˜0.1% and the iodide ions has a weight percentage of about 0.1˜10%.

The cross-linking agent may comprise boric acid or sodium tetraborate (Na₂B₄O₇), with concentration of about 1˜10 wt %, preferably 2˜5%. The extending tank further comprises potassium iodide (KI) of 1˜10 wt %, preferably 2˜5%.

### COMPARATIVE EXAMPLE 1

Specific quantities of polyvinyl alcohol powders were dissolved in water and heated to 80˜90° C. After cooling and filtering, a gel containing 5 wt % polyvinyl alcohol was prepared.

A polyvinyl alcohol film was swollen in a water tank. Next, the polyvinyl alcohol film was dyed with an iodine solution. The polyvinyl alcohol film was then stretched in an extending tank containing 4% boric acid and −4% potassium iodide (KI) to form an extended polyvinyl alcohol polarization film.

After drying, two saponified triacetyl cellulose (TAC) films were respectively laminated on the upper and lower surfaces of the polarization film by the gel to form a polarizer.

The color dispersion (a, b) and transmittance rate (Ys) of the polarizer were measured by an optical instrument. Referring to Table 1, the transmittance rate was 42.11%, a was −1.52, and b was 3.84.

### EXAMPLE 1

Specific quantities of polyvinyl alcohol powders were dissolved in water and heated to 80˜90° C. After cooling and filtering, a gel containing 5wt % polyvinyl alcohol was prepared. Specific quantities of blue dye 155 (BASANTOL U, BASF Chemical Co.) were then dissolved therein to form a transparent blue gel. The blue dye 155 and gel had a volume ratio of 1:1000.

A polyvinyl alcohol film was swollen in a water tank. Next, the polyvinyl alcohol film was dyed with an iodine solution. The polyvinyl alcohol film was then stretched in an extending tank containing 4% boric acid and 4% potassium iodide (KI) to form an extended polyvinyl alcohol polarization film.

After drying, two saponified triacetyl cellulose (TAC) films were respectively laminated on the upper and lower surfaces of the polarization film by the gel to form a polarizer.

The color dispersion (a, b) and transmittance rate (Ys) of the polarizer were measured by an optical instrument. Referring to Table 1, the transmittance rate was 41.45%, a was −1.22, and b was 3.08.

### EXAMPLE 2

Specific quantities of polyvinyl, alcohol powders were dissolved in water and heated to 80˜90° C. After cooling and filtering, a gel containing 5 wt % polyvinyl alcohol was prepared. Specific quantities of blue dye 155 (BASANTOL U, BASF Chemical Co.) were then dissolved therein to form a transparent blue gel. The blue dye 155 and gel had a volume ratio of 1:2000.

A polyvinyl alcohol film was swollen in a water tank. Next, the polyvinyl alcohol film was dyed with an iodine solution. The polyvinyl alcohol film was then stretched in an extending tank containing 4% boric acid and 4% potassium iodide (KI) to form an extended polyvinyl alcohol polarization film.

After drying, two saponified triacetyl cellulose (TAC) films were respectively laminated on the upper and lower surfaces of the polarization film by the gel to form a polarizer.

The color dispersion (a, b) and transmittance rate (Ys) of the polarizer were measured by an optical instrument. Referring to Table 1, the transmittance rate was 41.55%, a was −1.34, and b was 3.41.

### EXAMPLE 3

Specific quantities of polyvinyl alcohol powders were dissolved in water and heated to 80˜90° C. After cooling and filtering, a gel containing 5 wt % polyvinyl alcohol was prepared. Specific quantities of blue dye 155 (BASANTOL U, BASF Chemical Co.) were then dissolved therein to form a transparent blue gel. The blue dye 155 and gel had a volume ratio of 1:4000.

A polyvinyl alcohol film was swollen in a water tank. Next, the polyvinyl alcohol film was dyed with an iodine solution. The polyvinyl alcohol film was then stretched in an extending tank containing 4% boric acid and 4% potassium iodide (KI) to form an extended polyvinyl alcohol polarization film.

After drying, two saponified triacetyl cellulose (TAC) films were respectively laminated on the upper and lower surfaces of the polarization film by the gel to form a polarizer.

The color dispersion (a, b) and transmittance rate (Ys) of the polarizer were measured by an optical instrument. Referring to Table 1, the transmittance rate was 41.54%, a was −1.27, and b was 3.52.

### EXAMPLE 4

Specific quantities of polyvinyl alcohol powders were dissolved in water and heated to 80˜90° C. After cooling and filtering, a gel containing 5 wt % polyvinyl alcohol were prepared. Specific quantities of blue dye 155 (BASANTOL U, BASF Chemical Co.) was then dissolved therein to form a transparent blue gel. The blue dye 155 and gel had a volume ratio of 1:10000.

A polyvinyl alcohol film was swollen in a water tank. Next, the polyvinyl alcohol film was dyed with an iodine solution. The polyvinyl alcohol film was then stretched in an extending tank containing 4% boric acid and 4% potassium iodide (KI) to form an extended polyvinyl alcohol polarization film.

After drying, two saponified triacetyl cellulose (TAC) films were respectively laminated on the upper and lower surfaces of the polarization film by the gel to form a polarizer.

The color dispersion (a, b) and transmittance rate (Ys) of the polarizer were measured by an optical instrument. Referring to Table 1, the transmittance rate was 41.87%, a was −1.34, and b was 3.50.

### EXAMPLE 5

Specific quantities of polyvinyl alcohol powders were dissolved in water and heated to 80˜90° C. After cooling and filtering, a gel containing 5 wt % polyvinyl alcohol was prepared. Specific quantities of red dye 345 (BASANTOL U, BASF Chemical Co.) were then dissolved therein to form a transparent red gel. The red dye 345 and gel had a volume ratio of 1:1000.

A polyvinyl alcohol film was swollen in a water tank. Next, the polyvinyl alcohol film was dyed with an iodine solution. The polyvinyl alcohol film was then stretched in an extending tank containing 4% boric acid and 4% potassium iodide (KI) to form an extended polyvinyl alcohol polarization film.

After drying, two saponified triacetyl cellulose (TAC) films were respectively laminated on the upper and lower surfaces of the polarization film by the gel to form a polarizer.

The color dispersion (a, b) and transmittance rate (Ys) of the polarizer were measured by an optical instrument. Referring to Table 1, the transmittance rate was 40.83%, a was −0.33, and b was 3.04.

### EXAMPLE 6

Specific quantities of polyvinyl alcohol powders were dissolved in water and heated to 80˜90° C. After cooling and filtering, a gel containing 5 wt % polyvinyl alcohol was prepared. Specific quantities of yellow dye 155 (BASANTOL U, BASF Chemical Co.) were then dissolved therein to form a transparent yellow gel. The yellow dye 155 and gel had a volume ratio of 1:10000.

A polyvinyl alcohol film was swollen in a water tank. Next, the polyvinyl alcohol film was dyed with an iodine solution. The polyvinyl alcohol film was then stretched in an extending tank containing 4% boric acid and 4% potassium iodide (KI) to form an extended polyvinyl alcohol polarization film.

After drying, two saponified triacetyl cellulose (TAC) films were respectively laminated on the upper and lower surfaces of the polarization film by the gel to form a polarizer.

The color dispersion (a, b) and transmittance rate (Ys) of the polarizer were measured by an optical instrument. Referring to Table 1, the transmittance rate was 41.53%, a was −1.10, and b was 3.36.

### EXAMPLE 7

Specific quantities of polyvinyl alcohol powders were dissolved in water and heated to 80˜60° C. After cooling and filtering, a gel containing 5 wt % polyvinyl alcohol was prepared. Specific quantities of red dye 345 and yellow dye 155 (BASANTOL U, BASF Chemical Co.) were then dissolved therein to form a transparent orange gel. Both dyes had a volume ratio of 1:10000 to the gel.

A polyvinyl alcohol film was swollen in a water tank. Next, the polyvinyl alcohol film was dyed with an iodine solution. The polyvinyl alcohol film was then stretched in an extending tank containing 4% boric acid and 4% potassium iodide (KI) to form an extended polyvinyl alcohol polarization film.

After drying, two saponified triacetyl cellulose (TAC) films were respectively laminated on the upper and lower surfaces of the polarization film by the gel to form a polarizer.

The color dispersion (a, b) and transmittance rate (Ys) of the polarizer were measured by an optical instrument. Referring to Table 1, the transmittance rate was 41.29%, a was −0.84, and b was 3.20.

Optical data such as transmittance (Ys) and color dispersion (a, b) of comparative example 1 and examples 1˜7 are recited in Table 1. B represents blue dye, R represents red dye, Y represents yellow dye, and R+Y represents a mixture of red and blue dyes.

TABLE 1

| | Transmittance | | |
|---|---|---|---|
| Sample | (Ys) | a | b |
| Comparative | 42.11 | −1.52 | 3.84 |
| example 1 | | | |
| Example 1 | 41.45 | −1.22 | 3.08 |
| (B) | | | |
| Example 2 | 41.55 | −1.34 | 3.41 |
| (B) | | | |
| Example 3 | 41.54 | −1.27 | 3.52 |
| (B) | | | |
| Example 4 | 41.87 | −1.34 | 3.50 |
| (B) | | | |
| Example 5 | 40.83 | −0.33 | 3.04 |
| (R) | | | |
| Example 6 | 41.53 | −1.10 | 3.36 |
| (Y) | | | |
| Example 7 | 41.29 | −0.84 | 3.20 |
| (R + Y) | | | |

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A gel utilized in polarizer lamination, comprising:
a polyvinyl alcohol solution; and
a water-soluble organic dye dissolved therein.

2. The gel utilized in polarizer lamination as claimed in claim 1, wherein the water-soluble organic dye comprises blue, red, yellow, or a mixture thereof.

3. The gel utilized in polarizer lamination as claimed in claim 1, further comprising a polar organic solvent.

4. The gel utilized in polarizer lamination as claimed in claim 3, wherein the polar organic solvent comprises alcohol.

5. The gel utilized in polarizer lamination as claimed in claim 1, wherein the water-soluble organic dye is uniformly dissolved and dispersed in the polyvinyl alcohol solution.

6. The gel utilized in polarizer lamination as claimed in claim 1, wherein the gel is transparent.

7. A polarizer, comprising:
a polyvinyl alcohol film; and
at least one protective film laminated thereon by the gel as claimed in claim 1.

8. The polarizer as claimed in claim 7, wherein the protective film comprises triacetyl cellulose (TAC), polyethylene terephathalate (PET), cycloolefin polymer (COP), cycloolefin copolymer (COC), or polynorbomene.

9. The polarizer as claimed in claim 7, further comprising a compensative film, a brightness enhancement film, an anti-reflective film, or a combination thereof, laminated on the protective film by an adhesive.

10. The polarizer as claimed in claim 9, wherein the adhesive comprises pressure sensitive adhesive (PSA).

11. The polarizer as claimed in claim 7, wherein the polarizer has a color dispersion altered with various organic dyes added in the gel.

12. The polarizer as claimed in claim 7, wherein the polarizer has a transmittance of about 40.0˜70.0%.

13. The polarizer as claimed in claim 7, wherein the polarizer has a polarizing index exceeding 60.0%.

14. A method of fabricating a polarizer, comprising:
providing a polyvinyl alcohol film; and
laminating at least one protective film thereon by the gel as claimed in claim 1.

15. The method of fabricating a polarizer as claimed in claim 14, wherein the polyvinyl alcohol film is a dried film after being swollen, dyed, and stretched.

16. The method of fabricating a polarizer as claimed in claim 15, wherein the film is dyed with an iodine solution.

17. The method of fabricating a polarizer as claimed in claim 16, wherein the iodine solution comprises molecular iodine and iodide ions.

18. The method of fabricating a polarizer as claimed in claim 15, wherein the film is stretched in an extending tank containing a cross-linking agent.

19. The method of fabricating a polarizer as claimed in claim 18, wherein the cross-linking agent comprises boric acid or sodium tetraborate (Na₂B₄O₇).

20. The method of fabricating a polarizer as claimed in claim 14, wherein the protective film comprises triacetyl cellulose (TAC), polyethylene terephathalate (PET), cycloolefin polymer (COP), cycloolefin copolymer (COC), or polynorbomene.

21. The method of fabricating a polarizer as claimed in claim 14, further comprising laminating a compensative film, a brightness enhancement film, an anti-reflective film, or a combination thereof on the protective film by an adhesive.

22. The method of fabricating a polarizer as claimed in claim 21, wherein the adhesive comprises pressure sensitive adhesive (PSA).
